(19) United States
(12) Patent Application Publication
(10) Pub. No.: US 2025/0203334 A1
(43) Pub. Date: Jun. 19, 2025

(54) APPARATUS AND METHOD FOR CONTROLLING A VEHICLE

(71) Applicants: HYUNDAI MOTOR COMPANY, Seoul (KR); KIA CORPORATION, Seoul (KR)

(72) Inventors: Jae Hun Jung, Yongin-si (KR); Jae Hong Park, Busan (KR); Chan Woong Jeon, Incheon (KR); Myoung Won Lee, Hanam-si (KR)

(73) Assignees: HYUNDAI MOTOR COMPANY, Seoul (KR); KIA CORPORATION, Seoul (KR)

(21) Appl. No.: 18/774,602

(22) Filed: Jul. 16, 2024

(30) Foreign Application Priority Data
Dec. 19, 2023 (KR) 10-2023-0186230

(51) Int. Cl. H04W 4/90; G06V 20/58; G08G 1/00; H04W 4/46

(52) U.S. Cl. CPC H04W 4/90; G08G 1/202; H04W 4/46; G06V 20/58

(57) ABSTRACT

A vehicle control apparatus and method are provided. The vehicle control apparatus includes at least one sensor configured to identify an accident occurring in a vehicle. The vehicle control apparatus also includes a processor configured to transmit an accident signal, indicating occurrence of the accident, to an external electronic device based on identifying the occurrence of the accident in the vehicle by using the at least one sensor.

### CROSS-REFERENCE TO RELATED APPLICATION

This application claims the benefit of and priority to Korean Patent Application No. 10-2023-0186230, filed in the Korean Intellectual Property Office on Dec. 19, 2023, the entire contents of which are hereby incorporated herein by reference.

### TECHNICAL FIELD

The present disclosure relates to apparatus and method for controlling a vehicle, and more specifically, relates to a technology for obtaining information from a vehicle in which an accident occurs.

### BACKGROUND

With the recent advancement of autonomous driving or driving assistance technologies in vehicles, the monitoring of non-accident safety issues is required in North America as well as in Europe.

In North America, the need for monitoring non-accident safety issues is being emphasized through documents including safety cases. In Europe, the need for monitoring is identified in that non-accidents are considered as accidents in regulation R-157 and the German Road Traffic Act.

Regulatory compliance, conflict avoidance, and collision avoidance related to non-accident safety issues are emphasized through the behavioral capability dimension of an autonomous driving system.

Moreover, R-157 automated lane keeping system (ALKS) regulation in Europe mandates keeping a process of updating vehicles through closed-loop field monitoring for safety-related incidents and crashes or collisions. If critical incidents occur, the critical incidents are requested to be reported to the authorities.

In-service monitoring and reporting (ISMR) disclosed by validation method for automated driving (VMAD), European Autonomous Driving Evaluation Legislation Council, requires reporting on events related to critical incidents and non-critical incidents. The non-critical incidents may mean an interruption of operation, defect, failure, or other situations, which do not result in an accident or a serious accident although the non-critical incidents affect or may affect advanced driving systems (ADS). Furthermore, the non-critical incidents may include minor incidents, or safety degradation that affects normal operation.

Road traffic law in Germany expands the definition of an accident to include non-critical incidents, where a vehicle does not necessarily need to be involved in a collision, as it is sufficient to contribute to the occurrence of damage through driving style or traffic impact.

### SUMMARY

As a result, appropriate countermeasures are required.

The present disclosure was made to solve the above-mentioned problems occurring in the prior art while advantages achieved by the prior art are maintained intact.

Aspects of the present disclosure provide a vehicle control apparatus and method that obtain and share information related to an accident through at least part of vehicles related to the accident by using vehicle to everything (V2X).

Aspects of the present disclosure provide a vehicle control apparatus and method for providing an environment for exchanging or sharing accident-related information.

Aspects of the present disclosure provide a vehicle control apparatus and method that accurately analyze an accident, that has occurred, by collecting various pieces of information related to the accident.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a vehicle control apparatus is provided. The vehicle control apparatus may include at least one sensor configured to identify an accident occurring in a vehicle. The vehicle control apparatus may also include a processor configured to transmit an accident signal, indicating occurrence of the accident, to an external electronic device based on identifying the occurrence of the accident in the vehicle by using the at least one sensor.

According to an embodiment, the processor may further be configured to transmit information related to the accident to the external electronic device.

According to an embodiment, the information related to the accident may include at least one of a location at which the accident occurs, image information of specified duration including a time point at which the accident occurs, traffic situation information within a specified radius from the location after the accident occurs, vehicle information of the vehicle, a number of passengers in the vehicle, age information of one or more passengers in the vehicle, gender information of one or more passengers in the vehicle, a target to which the information related to the accident is to be transmitted, a rescue signal for the accident, or any combination thereof.

According to an embodiment, the processor may be configured to transmit at least one of i) the accident signal or ii) information related to the accident, or any combination thereof, to one or more external vehicles that are identified within a specified distance from the vehicle, based on identifying the occurrence of the accident. The one or more external vehicles may allow, in advance, reception of at least one of the accident signal, the information related to the accident, or any combination thereof.

According to an embodiment, the processor may be further configured to cause the information related to the accident to be displayed through one or more displays included in the one or more external vehicles.

According to an embodiment, the processor may be further configured to transmit location information, indicating a location at which the accident occurs, to the external electronic device. The processor may also be configured to transmit a rescue signal for causing at least one of an ambulance, a fire truck, a police car, or any combination thereof, to be dispatched to the location specified by the location information.

According t embodiment, the processor may be configured to transmit the accident signal to at least one of the external electronic device, an external vehicle, or any combination thereof, identified within a specified radius from the vehicle.

According to an embodiment, the processor may be configured to identify at least one external vehicle identifying the accident by using the image information. The processor may also be configured to cause the external electronic device to transmit a request signal requesting information related to the accident to the at least one external vehicle.

According to another aspect of the present disclosure, a vehicle control apparatus is provided. The vehicle control apparatus may include at least one sensor configured to identify an accident occurring in an external vehicle. The vehicle control apparatus may also include a processor configured to transmit an accident signal, indicating occurrence of the accident in the external vehicle, to an external electronic device based on identifying the occurrence of the accident in the external vehicle by using the at least one sensor.

According to an embodiment, the processor may be further configured to transmit information related to the accident to the external electronic device.

According to an embodiment, the information related to the accident may include at least one of a location at which the accident occurs, image information of specified duration including a time point at which the accident occurs, traffic situation information within a specified radius from the location after the accident occurs, vehicle information of the external vehicle, a number of passengers in the external vehicle, age information of one or more passengers in the external vehicle, gender information of one or more passengers in the external vehicle, a target to which the information related to the accident is to be transmitted, a rescue signal for the accident, or any combination thereof.

According to an embodiment, the processor may be configured to transmit image information of specified duration including a time point at which the accident occurs, to the external electronic device.

According to an embodiment, the processor may be configured to provide the external electronic device with information related to the accident based on receiving a request signal requesting the information related to the accident from the external electronic device.

According to an embodiment, the information related to the accident may be stored in at least one of the external electronic device, a communication relay station different from the external electronic device, a server storage associated with the external vehicle or a vehicle equipped with the vehicle control apparatus, an electronic device including a terminal owned by a pedestrian, or any combination thereof, when the information related to the accident is transmitted to the external electronic device.

According to another aspect of the present disclosure, a communication method is provided. The communication method includes receiving, by a processor, an accident signal indicating occurrence of an accident, from at least one of a first vehicle in which the accident occurs, a second vehicle that identifies the accident by using a sensor, or any combination thereof, through a communication circuit. The communication method also includes transmitting a request signal for requesting information related to the accident to vehicles including the first vehicle and the second vehicle based on receiving the accident signal. The communication method further includes receiving the information related to the accident from at least some vehicles responding to the request signal. The vehicles may agree to transmission of the information related to the accident to a communication center.

According to an embodiment, the information related to the accident may include at least one of a location at which the accident occurs, image information of specified duration including a time point at which the accident occurs, traffic situation information within a specified radius from the location after the accident occurs, vehicle information of the first vehicle, a number of passengers in the first vehicle, age information of one or more passengers in the first vehicle, gender information of one or more passengers in the first vehicle, a target to which the information related to the accident is to be transmitted, a rescue signal for the accident, or any combination thereof.

According to an embodiment, the communication method may further include transmitting the request signal requesting the information related to the accident to vehicles identified in image information based on receiving the image information within specified duration from a time point at which the accident occurs, from the first vehicle.

According to an embodiment, the communication method may further include identifying at least one of a location of the first vehicle or a location where the accident occurs based on map information. The communication method may also include transmitting a request signal for requesting the information related to the accident to at least one of i) vehicles located within a specified radius from a location of the first vehicle or a location where the accident occurs, ii) vehicles passing a specified radius for specified duration, or any combination thereof.

According to an embodiment, the communication method may further include requesting vehicle information related to the accident from the first vehicle. The communication method may also include providing an environment in which vehicles other than the first vehicle and the first vehicle share the information related to the accident with each other. The vehicle information may include at least one of an identifier of the first vehicle, a location at which the accident occurs, a number of passengers in the first vehicle, age information of one or more passengers in the first vehicle, gender information of one or more passengers in the first vehicle, a target to which the information related to the accident is to be transmitted, a rescue signal for the accident, or any combination thereof. The information related to the accident may include at least one of image information of specified duration including a time point at which the accident occurs, traffic situation information within a specified radius from the location after the accident occurs, a location where the accident occurs, information related to an accident victim by the accident, or any combination thereof.

According to an embodiment, the communication method may further include allowing establishment of a communication link through the communication circuit from the first vehicle and the second vehicle before the accident occurs.

### BRIEF DESCRIPTION OF THE DRAWINGS

The above and other objects, features, and advantages of the present disclosure should be more apparent from the following detailed description taken in conjunction with the accompanying drawings, in which:

FIG. 1A shows a block diagram of a vehicle control apparatus, according to an embodiment of the present disclosure;

FIG. 1B shows a block diagram of a communication center, according to an embodiment of the present disclosure;

FIG. 2 shows an example in which information related to an accident is transmitted, according to an embodiment of the present disclosure;

FIG. 3 shows an example related to an accident, according to an embodiment of the present disclosure;

FIG. 4 shows a flowchart of a communication method, according to an embodiment of the present disclosure;

FIG. 5 shows a signal flow chart related to a communication system, according to an embodiment of the present disclosure; and

FIG. 6 shows a computing system related to a vehicle control apparatus or communication method, according to an embodiment of the present disclosure.

### DETAILED DESCRIPTION

Hereinafter, embodiments of the present disclosure are described in detail with reference to the accompanying drawings. In adding reference numerals to components of the drawings, it should be noted that the same or equivalent components are designated by the same reference numerals even when the components are shown on different drawings. Furthermore, in describing the embodiments of the present disclosure, detailed description associated with well-known functions or configurations has been omitted where it was determined that the detailed description would unnecessarily obscure the gist of the present disclosure.

In describing elements of embodiments of the present disclosure, the terms first, second, A, B, (a), (b), and the like may be used herein. These terms are only used to distinguish one element from another element. The terms do not limit the corresponding elements irrespective of the nature, order, or priority of the elements. Furthermore, unless otherwise defined, all terms including technical and scientific terms used herein should be interpreted as is customary in the art to which the present disclosure pertains. It should be understood that terms used herein should be interpreted as including a meaning that is consistent with their meaning in the context of the present disclosure and the relevant art. The terms should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or perform that operation or function.

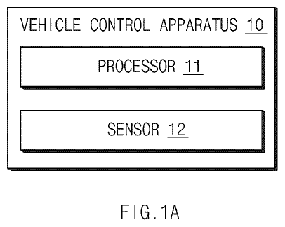

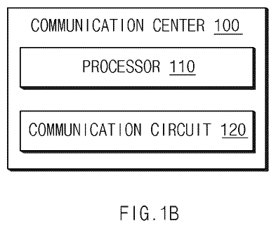

Hereinafter, embodiments of the present disclosure are described in detail with reference to FIGS. 1A-6.

FIG. 1A shows a block diagram of a vehicle control apparatus, according to an embodiment of the present disclosure.

A vehicle control apparatus 10 according to an embodiment may include a processor 11 and at least one sensor 12. For example, the vehicle control apparatus 10 may include the at least one sensor 12 for identifying an accident occurring in a vehicle that is equipped with the vehicle control apparatus 10. As another example, the vehicle control apparatus 10 may include the at least one sensor 12 for identifying an accident occurring in an external vehicle.

The processor 11 and the at least one sensor 12 may be electrically and/or operably coupled with each other by an electronic component including a communication bus.

In various examples, the vehicle control apparatus 10 may be mounted on an accident vehicle in which an accident occurs and/or a witness vehicle that witnessed the accident.

The at least one sensor 12 of the vehicle control apparatus 10 may include a sensor for identifying an accident occurring in the vehicle and/or a sensor for identifying an accident occurring in an external vehicle.

The at least one sensor 12 for identifying an accident occurring in the vehicle may include at least one of a camera, a Light Detection and Ranging (LiDAR), a radar, an impact detection sensor, or any combination thereof.

The at least one sensor 12 for identifying an accident occurring in an external vehicle may include at least one sensor for obtaining external environments of the vehicle including the camera, the LiDAR, and/or the radar.

Hereinafter, an example operation of the vehicle control apparatus 10 when the vehicle control apparatus 10 is included in an accident vehicle in which an accident occurs is described.

The processor 11 of the vehicle control apparatus 10 according to an embodiment may identify an accident occurring in the vehicle by using the at least one sensor 12. The processor 11 of the vehicle control apparatus 10 may transmit an accident signal indicating occurrence of the accident, to an external electronic device based on identifying the occurrence of the accident in the vehicle by using the at least one sensor 12.

According to an embodiment, the processor 11 may (e.g., together with transmitting the accident signal) transmit information related to the accident to the external electronic device. In an example, the external electronic device may include a relay station including a communication center.

The information related to an accident may include at least one of a location at which the accident occurs, image information of specified duration including a time point at which the accident occurs, traffic situation information within a specified radius from the location where the accident occurs after the accident occurs, vehicle information of the vehicle where the accident occurs, a number of passengers in a vehicle where the accident occurs, age information of one or more passengers in the vehicle where the accident occurs, gender information of one or more passengers in the vehicle where the accident occurs, a target to which information related to the accident is to be transmitted, a rescue signal for the accident, or any combination thereof.

The processor 11 may transmit at least one of an accident signal or information related to the accident to external vehicles that are identified within a specified distance from the vehicle based on identifying the occurrence of the accident.

In an example, the external vehicles may allow, in advance, the reception of at least one of an accident signal, information related to an accident, or any combination thereof. For example, the external vehicles may allow the reception of at least one of an accident signal, information related to an accident, or any combination thereof, before the accident occurs.

According to an embodiment, the processor 11 may (e.g., together with transmitting information related to the accident) cause the information related to the accident to be displayed through displays included in the external vehicles.

For example, while transmitting an accident signal, the processor 11 may transmit, to the external electronic device, location information indicating that the accident has occurred. The processor 11 may also transmit a rescue signal for causing at least one of an ambulance, a fire truck, a police car, or any combination thereof, to be dispatched to a location where an accident specified by the location information occurs.

According to an embodiment, the processor 11 may transmit an accident signal to at least one of an external electronic device, an external vehicle, or any combination thereof, identified within a specified radius from the vehicle.

According to an embodiment, the processor 11 may obtain image information including a time point at which the accident occurs. The processor 11 may identify at least one external vehicle identifying the accident by using the image information. The processor 11 may cause an external electronic device to transmit a request signal requesting information related to the accident to the at least one external vehicle identifying the accident.

Hereinafter, an example operation of the vehicle control apparatus 10 when the vehicle control apparatus 10 is included in a witness vehicle that witnessed the accident is described.

The processor 11 of the vehicle control apparatus 10 according to an embodiment may identify an accident occurring in an external vehicle based on at least one sensor. In an example, the processor 11 may transmit an accident signal, indicating occurrence of an accident occurs in an external vehicle, to an external electronic device based on identifying the occurrence of the accident in the external vehicle by using at least one sensor.

According to an embodiment, the processor 11 may (e.g., together with the accident signal) transmit information related to the accident to the external electronic device.

Information related to an accident may include at least one of a location at which the accident occurs, image information of specified duration including a time point at which the accident occurs, traffic situation information within a specified radius from the location where the accident occurs after the accident occurs, vehicle information of an external vehicle, a number of passengers in the external vehicle, age information of one or more passengers in the external vehicle, gender information of one or more passengers in the external vehicle, a target to which information related to the accident is to be transmitted, a rescue signal for the accident, or any combination thereof.

According to an embodiment, the processor 11 may transmit image information of a specified duration including a time point, at which the accident occurs, to the external electronic device. According to an embodiment, the processor 11 may transmit image information of a specified duration including a time point, at which the accident occurs, to the vehicle through the external electronic device.

As described above, the vehicle control apparatus 10 according to an embodiment may identify an accident occurring in a vehicle and may notify surrounding vehicles of the accident, thereby relatively quickly identifying the occurrence of the accident.

FIG. 1B shows a block diagram related to a communication center, according to an embodiment of the present disclosure.

A communication center 100 may include a processor 110 and a communication circuit 120. The processor 110 and the communication circuit 120 may be electrically and/or operably coupled with each other by an electronic component including a communication bus.

Herein, when pieces of hardware are described as being coupled operably, this may include a direct and/or indirect connection between the pieces of hardware established by in a wired manner and/or wirelessly such that second hardware is controlled by first hardware among the pieces of hardware.

Although are different blocks shown, the present disclosure is not limited thereto. Some of the pieces of hardware in FIG. 1A and/or may be included in a single integrated circuit including a system on a chip (SoC). The type and/or number of hardware included in the communication center 100 is not limited to that shown in FIG. 1B. For example, the communication center 100 may include only some of the pieces of hardware shown in FIG. 1B.

The communication center 100 according to an embodiment may include hardware for processing data based on one or more instructions. The hardware for processing data may include the processor 110.

For example, the hardware for processing data may include an arithmetic and logic unit (ALU), a floating point unit (FPU), a field programmable gate array (FPGA), a central processing unit (CPU), and/or an application processor (AP). The processor 110 may include a structure of a single-core processor, or may include a structure of a multi-core processor including a dual core, a quad core, a hexa core, or an octa core.

The communication circuit 120 of the communication center 100 according to an embodiment may include a hardware component for supporting transmission and/or reception of signals between the communication center 100 and an external electronic device. For example, the communication circuit 120 may include at least one of a MODEM, an antenna, an optical/electronic (0/E) converter, or any combination thereof.

For example, the communication circuit 120 may support transmission and/or reception of signals based on various types of protocols including at least one of Ethernet, local area network (LAN), wide area network (WAN), WiFi, Bluetooth, Bluetooth low energy (BLE), ZigBee, long term evolution (LTE), 5G new radio (NR), controller area network (CAN), local interconnect network (LIN), or any combination thereof.

The communication circuit 120 of the communication center 100 may establish a communication link with vehicles. In an example, the communication center 100 may receive a permission message for allowing the establishment of a communication link with vehicles from the vehicles through the communication circuit 120. For example, the processor 110 of the communication center 100 may establish a communication link with vehicles based on the permission message.

According to an embodiment, the processor 110 may establish a communication link with a first vehicle, in which an accident occurs, and a second vehicle that identifies the accident of the first vehicle based on at least one sensor, through the communication circuit 120. For example, the first vehicle may include an accident vehicle in which the accident occurs. The second vehicle may include a witness vehicle identifying the accident.

In embodiments of the present disclosure, the accident may include a contact accident between vehicles and/or a non-contact accident in which no contact occurs between vehicles, but the accident of the first vehicle is caused by a vehicle. Furthermore, the communication center 100 may perform a process (or operation) of the present disclosure not only in situations where an accident actually occurs, but also in situations where an accident is likely to occur.

According to an embodiment, the processor 110 may receive an accident signal indicating occurrence of an accident in the first vehicle, from at least one of the first vehicle in which the accident occurs or the second vehicle that identifies the accident by using a sensor, through the communication circuit 120.

According to an embodiment, the processor 110 may transmit a request signal requesting information related to an accident to vehicles including the first vehicle and the second vehicle based on receiving the accident signal.

In an example, the processor 110 may broadcast a request requesting information related to an accident to vehicles including the first vehicle and the second vehicle.

For example, the processor 110 making a request for information related to an accident to the vehicles may include at least one of unicast, broadcast, multicast, anycast, geocast, or any combination thereof.

According to an embodiment, the processor 110 may receive information related to an accident from at least some vehicles responding to the request signal.

For example, the processor 110 may receive information related to an accident from at least some vehicles responding to broadcasting.

The information related to an accident may include at least one of a location at which the accident occurs, image information of specified duration from a time point at which the accident occurs, traffic situation information within a specified radius from the location where the accident occurs after the accident occurs, vehicle information of the first vehicle, a number of passengers in the first vehicle, age information of one or more passengers in the first vehicle, gender information of one or more passengers in the first vehicle, a target to which information related to the accident is to be transmitted, a rescue signal for the accident, or any combination thereof.

For example, the first vehicle may transmit, to the communication center 100, at least one of the vehicle information of the first vehicle, the number of passengers in the first vehicle, the age information of one or more passengers in the first vehicle, the gender information of one or more passengers in the first vehicle, the target to which information related to the accident is to be transmitted, the rescue signal for the accident, or any combination thereof among the information related to the accident.

In an example, the target to which information related to the accident is to be transmitted may include at least one of a communication relay station different from the communication center 100, an electronic device including a terminal owned by a user, an external vehicle involved in an accident together with the first vehicle, or any combination thereof.

For example, the second vehicle may transmit, to the communication center 100, information related to at least one of image information of specified duration from a time point where an accident occurs, traffic situation information within a specified radius from a location where the accident occurs after the accident occurs, a location where the accident occurs, an accident victim who was separated from the first vehicle by the accident, an accident victim by the accident, or any combination thereof.

In an example, vehicles including the first vehicle and the second vehicle may establish a communication link with the communication center 100. The vehicles including the first vehicle and the second vehicle may, for example, include vehicles that agree to the transmission of information related to the accident to the communication center 100. For example, the vehicles including the first vehicle and the second vehicle may agree to the transmission of information related to the accident to the communication center 100 before the accident occurs.

According to an embodiment, the processor 110 may receive image information within specified duration from a time point at which the accident occurs, from the first vehicle. The image information within the specified duration may include a video including the time point at which the accident occurs.

According to an embodiment, the processor 110 may transmit a request signal requesting information related to an accident to vehicles that are identified in image information, based on receiving the image information within specified duration from a time point at which the accident occurs, from the first vehicle.

According to an embodiment, the processor 110 may identify at least one of a location of the first vehicle, a location where the accident occurs, or any combination thereof based on map information. For example, the map information may include at least one of a precision map, or navigation mapping information, or any combination thereof.

According to an embodiment, the processor 110 may make a request for the information related to the accident to at least one of vehicles located within a specified radius from a location of the first vehicle or a location where the accident occurs, vehicles passing the specified radius for specified duration, or any combination thereof.

According to an embodiment, the processor 110 may request vehicle information related to the accident from the first vehicle. For example, the processor 110 may make a request for vehicle information related to an accident that is directly and/or indirectly associated with the first vehicle, to the first vehicle. For example, the vehicle information related to an accident directly and/or indirectly associated with the first vehicle may include at least one of specification information of the first vehicle, a location at which the accident occurs, a number of passengers boarding the first vehicle, information about one or more passengers boarding the first vehicle, a target to which information related to the accident is to be transmitted, an emergency rescue signal, or any combination thereof. In an example, the information about passengers boarding the first vehicle may include at least one of a passenger's age, the passenger's gender, or any combination thereof.

According to an embodiment, the processor 110 may transmit information related to the accident to at least one of emergency rescue center, a transportation center, or any an combination thereof.

According to an embodiment, the processor 110 may provide an environment in which the vehicles other than the first vehicle and the first vehicle share information related to the accident with each other.

For example, the processor 110 may provide the environment for sharing the information related to the accident, thereby causing a first user of the first vehicle to provide compensation to a second user who provides the information related to the accident.

As described above, according to an embodiment, the processor 110 of the communication center 100 may transmit and/or receive information related to an accident to various vehicles related to the accident based on vehicle to everything (V2X), thereby easily responding to the accident after the accident occurs.

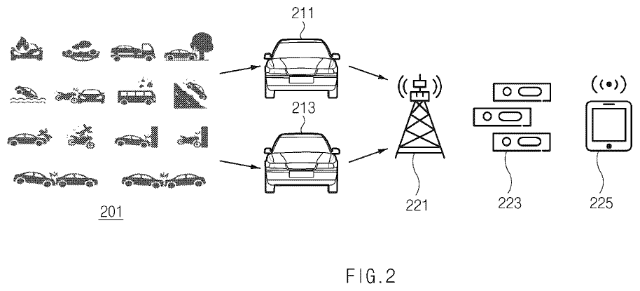

FIG. 2 shows an example in which information related to an accident is transmitted, according to an embodiment of the present disclosure.

Referring to FIG. 2, in an example 201, at least one of a first vehicle 211, a second vehicle 213, or any combination thereof may determine (or identify) an accident.

In an example, at least one of the first vehicle 211, the second vehicle 213, or any combination thereof may transmit an accident signal indicating occurrence of an accident, based on identifying the accident.

The first vehicle 211, the second vehicle 213, and/or vehicles described below may include vehicles that agree to the transmission of information to a communication center.

A processor (e.g., the processor 110 in FIG. 1) of the communication center (e.g., the communication center 100 in FIG. 1) may receive an accident signal indicating occurrence of an accident, from at least one of the first vehicle 211, the second vehicle 213, or any combination thereof. For example, the first vehicle 211 and/or the second vehicle 213 may transmit, to the communication center, the accident signal indicating the occurrence of the accident. Referring to the example 201, the accident may include a contact accident and/or a non-contact accident.

In an example, the first vehicle 211 may identify at least one passenger boarding the first vehicle 211 based on at least one camera (or sensor) included in the first vehicle 211. The first vehicle 211 may obtain passenger information related to at least one passenger based on identifying the at least one passenger boarding the first vehicle 211.

For example, the passenger information related to at least one passenger may be obtained based on being received from an external electronic device (e.g., a server) through a communication circuit. In an example, the passenger information related to at least one passenger may be obtained based on passenger information stored in the communication center.

For example, the sensor may include a V2X sensor. The V2X sensor may include at least one of radar, LiDAR, a camera, a gyroscope, an accelerometer, a global positioning system (GPS), or any combination thereof.

The first vehicle 211 may transmit sensor information obtained through the V2X sensor to the communication center. The communication center receiving the sensor information may identify vehicles based on the sensor information. For example, the communication center may identify vehicles based on image information among the sensor information. In an example, the communication center may identify vehicles related to the accident based on at least one of whether a vehicle is registered in the communication center, a license plate identified in the image information, an identifier of a V2X sensor, or any combination thereof. The communication center may make a request for information related to the accident to vehicles related to the accident, based on identifying the vehicles related to the accident.

According to an embodiment, the second vehicle 213 may identify the accident occurring in the first vehicle 211 based on at least one camera (or other sensor) included in the second vehicle 213. The second vehicle 213 may identify the accident occurring in the first vehicle 211 through a black box mounted on the second vehicle 213.

According to an embodiment, the second vehicle 213 may transmit information related to the accident occurring in the first vehicle 211 to the communication center. For example, the information related to the accident occurring in the first vehicle 211 may include at least one of image information including a time point where the accident occurs, traffic information surrounding a location where the accident occurs, or any combination thereof.

In an example, the communication center receiving information related to the accident from the second vehicle 213 may transmit information related to the accident to at least one of a relay station 221, a server 223, an external electronic device 225 owned by a user, or any combination thereof so as to be stored.

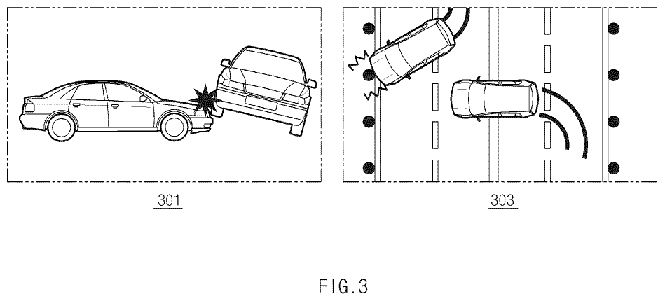

FIG. 3 shows an example related to an accident, according to an embodiment of the present disclosure.

Referring to FIG. 3, a first example 301 may include an example of a contact accident where a direct contact occurs between vehicles. A second example 303 may include an example in which an accident that occurs in a first vehicle is caused by a vehicle different from the first vehicle, although direct contact did not occur between vehicles.

For example, the first example 301 may include an example in which a direct contact (or collision) occurs between vehicles. A vehicle different from contacted vehicles may identify the accident in the first example 301, and may transmit information related to the identified accident to the communication center.

The second example 303 may be an example in which a direct contact did not occur between vehicles, but an accident in the first vehicle was caused by another vehicle. The second example 303 may include an example in which a vehicle causing an accident to the first vehicle, or other vehicles identified within a specified radius from the first vehicle, identify the accident to the first vehicle and transmit information related to the identified accident to the communication center in a situation including the second example 303.

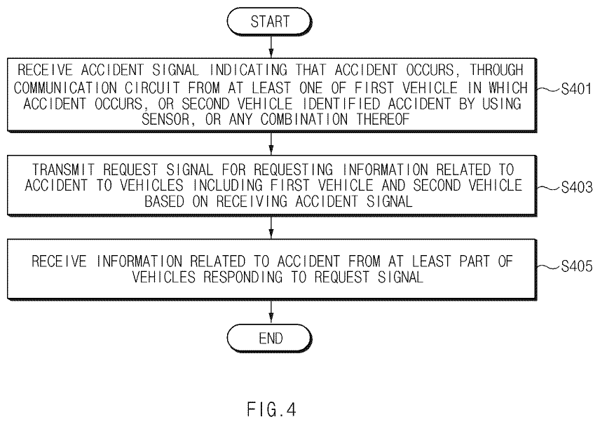

FIG. 4 shows a flowchart related to a communication method, according to an embodiment of the present disclosure.

Hereinafter, it is assumed that the communication center 100 of FIG. 1 performs the process of FIG. 4. In addition, in the description of FIG. 4, it should be understood that an operation described as being performed by a device is controlled by the processor 110 of the communication center 100.

At least one of operations of FIG. 4 may be performed by the communication center 100 of FIG. 1. At least one of operations of FIG. 4 may be performed by the processor 110 of FIG. 1. Each of the operations in FIG. 4 may be performed sequentially, but is not necessarily sequentially performed. For example, the order of operations may be changed and/or at least two operations may be performed in parallel.

Referring to FIG. 4, in an operation S401, an accident signal indicating that an accident occurs may be received through a communication circuit from at least one of a first vehicle in which the accident occurs, a second vehicle identifying the accident by using a sensor, or any combination thereof.

The communication method according to an embodiment may include an operation of f allowing the establishment of a communication link between a first vehicle, a second vehicle, and a communication center before an accident occurs. For example, the communication method may include an operation of allowing the establishment of a communication link between vehicles and a communication center, through a communication circuit.

In an operation S403, a request signal requesting information related to the accident may be transmitted to vehicles including the first vehicle and the second vehicle based on receiving the accident signal.

In an example, the vehicles including the first vehicle and the second vehicle may include vehicles that agree to the transmission of information related to the accident to the communication center.

The information related to an accident may include at least one of a location at which the accident occurs, image information of specified duration including a time point at which the accident occurs, traffic situation information within a specified radius from the location where the accident occurs after the accident occurs, vehicle information of the first vehicle, a number of passengers in the first vehicle, age information of one or more passengers in the first vehicle, gender information of one or more passengers in the first vehicle, a target to which information related to the accident is to be transmitted, a rescue signal for the accident, or any combination thereof.

The communication method according to an embodiment may include an operation of receiving image information within a specified duration from a time point at which the accident occurs, from the first vehicle. For example, the communication method may include an operation of transmitting a request signal requesting information related to an accident to vehicles identified in image information based on receiving the image information within a specified duration from a time point at which the accident occurs, from the first vehicle.

The communication method according to an embodiment may include an operation of identifying at least one of a location of the first vehicle, a location where the accident occurs, or any combination thereof based on map information. The communication method may include an operation of transmitting a request signal requesting information related to the accident to at least one of vehicles located within a specified radius from a location of the first vehicle or a location where the accident occurs, vehicles passing a specified radius for specified duration, or any combination thereof.

The communication method according to an embodiment may include an operation of requesting vehicle information related to the accident from the first vehicle. For example, the communication method may include an operation of providing an environment in which the remaining vehicles other than the first vehicle among vehicles including the first vehicle and the second vehicle, and the first vehicle share information related to the accident with each other.

In an example, the environment for sharing information related to an accident may include various environments including at least one of a platform, a system, or a community, or any combination thereof.

In an operation S405, information related to an accident may be received from at least part of vehicles responding to the request signal.

The communication method according to an embodiment may include an operation of transmitting information related to the accident to at least one of an emergency rescue center, a transportation center, or any combination thereof.

For example, the emergency rescue center may provide services for supporting rescue personnel at the location where an accident occurs in the first vehicle.

For example, the transportation center may provide services related to traffic information at a location where the accident occurs, or in an area where the accident occurs.

As mentioned above, the communication method according to an embodiment may include an operation of collecting information related to the accident and providing information sharing (or an information transaction) between the first vehicle corresponding to an accident victim and the second vehicle corresponding to an accident witness.

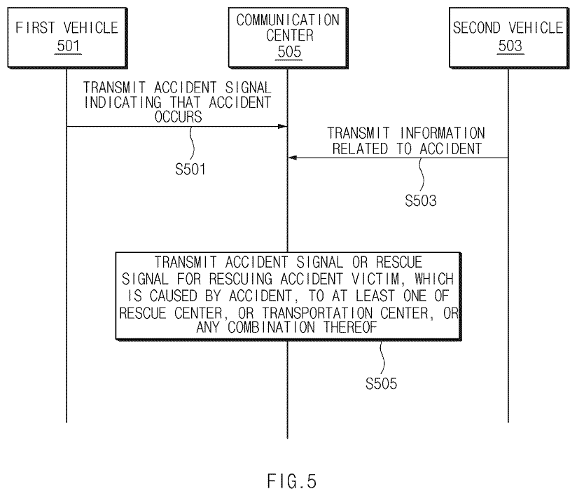

FIG. 5 shows a signal flow chart related to a communication system, according to an embodiment of the present disclosure.

Referring to FIG. 5, a communication system may include a first vehicle 501, a second vehicle 503, and a communication center 505. The first vehicle 501 may include a vehicle in which an accident occurs. The second vehicle 503 may include a vehicle identifying an accident to the first vehicle 501 by using a sensor. The communication center 505 may establish a communication link with the first vehicle 501 and the second vehicle 503.

In an operation S501, according to an embodiment, the first vehicle 501 may transmit, to the communication center, an accident signal indicating that an accident occurs.

According to an embodiment, the first vehicle 501 may transmit, to external electronic devices identified within a specified distance from the first vehicle 501, at least one of information related to the first vehicle 501, a location where an accident occurs, a number of passengers boarding the first vehicle 501, passenger information boarding the first vehicle 501, a target to which information related to the accident is to be transmitted, a rescue signal for the accident, or any combination thereof.

For example, the external electronic devices may include at least one of a control apparatus included in vehicles, an electronic device including a terminal owned by a pedestrian, a communication relay station, a first aid station, or any combination thereof. The terminal owned by a pedestrian may include at least one of a mobile phone, a laptop, a tablet PC, a wearable device, or any combination thereof. However, the present disclosure is not limited to the above description.

According to an embodiment, the first vehicle 501 may broadcast, within a specified radius from the first vehicle 501, at least one of vehicle information, specification information, passenger information, or any combination thereof, of the first vehicle 501. For example, according to settings set by a user of the first vehicle 501, the first vehicle 501 may broadcast the information of the first vehicle 501 within a specified radius from the first vehicle 501 in response to identifying occurrence of a contact accident. According to another embodiment, according to the settings set by a user of the first vehicle 501, the first vehicle 501 may broadcast the information of the first vehicle 501 within the specified radius from the first vehicle 501 based on executing a specified operation (or process).

According to an embodiment, the first vehicle 501 may transmit, to external electronic devices identified within a specified distance (e.g., a specified radius) from the first vehicle 501, at least one of vehicle information, specification information, passenger information, or any combination thereof of the first vehicle 501.

The information broadcast (or transmitted) by the first vehicle 501 is not limited to the above description. For example, the first vehicle 501 may broadcast (or transmit) at least one of vehicle information of the first vehicle 501, specification information of the first vehicle 501, a location where an accident occurs, a number of passengers boarding the first vehicle 501, passenger information of the first vehicle 501, a final destination (e.g., a relay station or an application) to which information is to be transmitted, an emergency rescue signal, or any combination thereof.

In an operation S503, according to an embodiment, the second vehicle 503 may transmit information related to the accident.

In embodiments of the present disclosure, the second vehicle 503 is described. However, the present disclosure is not limited thereto. For example, an accident that occurs in the first vehicle 501 may be identified through various devices including external electronic devices (e.g., a pedestrian-owned terminal, a closed-circuit television (CCTV), or a camera) located within a specified radius from the first vehicle 501 (i.e., a vehicle where an accident occurs), rather than the second vehicle 503. Such information related to the accident may be transmitted to the communication center 505.

In an example, the first vehicle 501 and the second vehicle 503 may agree to the transmission of information related to the accident to the communication center 505.

For example, the information related to an accident may include at least one of a location at which the accident occurs, image information of specified duration including a time point at which the accident occurs, traffic situation information within a specified radius from the location where the accident occurs after the accident occurs, vehicle information (or specification information) of the first vehicle, a number of passengers in the first vehicle, age information of one or more passengers in the first vehicle, gender information of one or more passengers in the first vehicle, a target to which information related to the accident is to be transmitted, a rescue signal for the accident, or any combination thereof.

According to an embodiment, the second vehicle 503 may identify a contact accident and/or a non-contact accident to the first vehicle 501. For example, the second vehicle 503 may identify the non-contact accident to the first vehicle 501 based on at least one of a sound signal of which the level is greater than or equal to a specified level, a sudden change in a direction of the first vehicle 501, a departure from a lane of the first vehicle 501, or any combination thereof. However, the present disclosure is not limited to the above description.

In an operation S505, the communication center 505 according to an embodiment may transmit an accident signal or a rescue signal for rescuing an accident victim as a result of an accident, to at least one of a rescue center, a transportation center, or any combination thereof.

The communication center 505 according to an embodiment may transmit information related to the location at which the accident occurs, to at least some vehicles passing through the location at which the accident occurs, in a specified duration including at time point at which the accident occurs. The communication center 505 may thus request the information related to the accident.

The communication center 505 according to an embodiment may identify vehicles that agree to the sharing of the information related to the accident among vehicles within a specified radius from the location where the accident occurs.

The communication center 505 according to an embodiment may identify that an accident occurs in the first vehicle 501, based on receiving information (e.g., an emergency rescue signal) related to the accident from at least one of the first vehicle 501, the second vehicle 503, or any combination thereof.

The communication center 505 according to an embodiment may identify a location (or region) where the accident occurs based on the information related to the accident. For example, the communication center 505 may transmit a request signal requesting the information related to the accident to vehicles that are identified within the area where the accident occurs, based on identifying the location (or region) where the accident occurs. Alternatively, on the basis of selecting vehicles, each of which transmits the request signal, within the area where the accident occurs, the communication center 505 may transmit a request signal to the selected vehicles. The communication center 505 according to another embodiment may perform broadcasting for requesting the information related to the accident toward the area where the accident occurs.

The communication center 505 according to an embodiment may store the received information related to the accident in a memory (or a server) based on receiving information related to the accident. The following descriptions may include various pieces of information included in the information related to the accident.

For example, the communication center 505 may store the obtained image in the memory (or the server) based on obtaining an image of a specified duration including a time point where the accident occurs. For example, the image of a specified duration including the time point at which the accident occurs may include an image with a length of approximately 3 seconds before and after the time point at which the accident occurs (with the total length of approximately 6 seconds).

For example, the communication center 505 may store location information related to the location at which the accident occurs, in the memory (or the server). The location information related to the location where the accident occurs may include, for example, coordinates of the location where the accident occurs. For example, the coordinates of the location where the accident occurs may be expressed in an absolute coordinate system. For example, the coordinates of the location where the accident occurs may include a coordinate value representing the location at which the accident occurs, within specified map information.

In an example, on the basis of obtaining traffic situation information within an area (or range) within a specified radius from the location where the accident occurs, the communication center 505 may store the obtained traffic situation information in the memory (or the server). For example, the traffic situation information may be obtained based on at least one of various communication protocols. For example, the various communication protocols may include at least one of dedicated short-range communications (DSRC), long term evolution for vehicle (LTE-V), 5G new radio (NR), Internet of things (IoT), intelligent transport systems-G5 (ITS-G5), or any combination thereof. The various communication protocols are not limited to the examples described above.

For example, the communication center 505 may store, in the memory (or the server), at least one of a passenger who separated from (or detached from) the first vehicle 501, information about a passenger boarding the first vehicle 501, or any combination thereof based on the accident to the first vehicle 501. For example, the information about the passenger boarding the first vehicle 501 may include the number of people boarding the first vehicle 501.

The communication center 505 according to an embodiment may transmit information related to the accident to at least one of an emergency rescue center, a transportation center, or any combination thereof. For example, to prevent secondary accidents from occurring, the communication center 505 according to an embodiment may transmit the information related to the accident to at least one of an emergency rescue center, a transportation center, or any combination thereof.

As mentioned above, according to an embodiment, the communication system including the first vehicle 501, the second vehicle 503, and the communication center 505 may receive the information related to the accident involving the first vehicle 501 from the first vehicle 501 and/or the second vehicle 503, thereby quickly identifying an accident involving the first vehicle 501 and quickly analyzing a situation related to the accident.

Moreover, the communication system may quickly collect the information related to the accident matched with vehicle information (or identification information) of the first vehicle 501. A user of the first vehicle 501 may perform insurance processing and/or accident processing based on rapid situation analysis of the accident by using the communication system.

A user of the second vehicle 503 witnessing the accident may deliver the information related to the accident to the first vehicle 501 or the user of the first vehicle 501, thereby receiving compensation from the first vehicle 501 or the user of the first vehicle 501.

Furthermore, various businesses (e.g., information transaction relay-related businesses) may be developed by using the communication system.

As described above, the communication system according to an embodiment may perform accurate accident analysis by collecting and/or analyzing information related to many accidents. The manufacturer that manufactures the first vehicle 501 and/or the second vehicle 503 may include an advantage in vehicle development, certification, and regulatory compliance by using information related to accidents. As described above, the communication system according to an embodiment may provide effects in various fields from various perspectives.

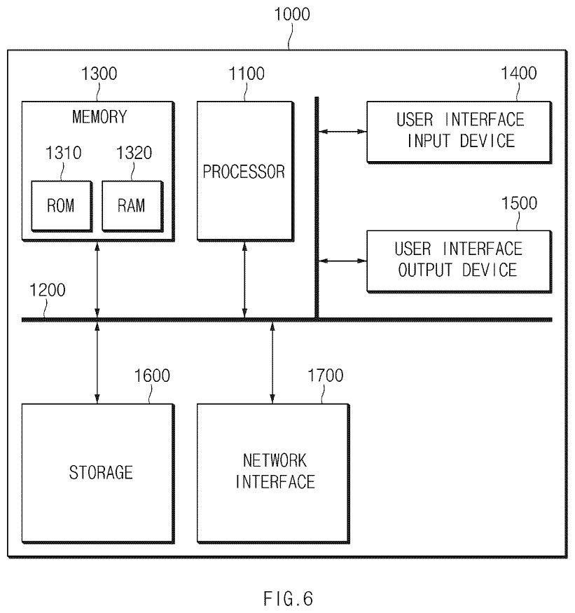

FIG. 6 shows a computing system related to a vehicle control apparatus or communication method, according to an embodiment of the present disclosure.

Referring to FIG. 6, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The storage medium is coupled to the processor 1100, and the processor 1100 may read information from the storage medium and may write information in the storage medium. In another embodiment, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

Hereinabove, although the present disclosure has been described with reference to certain n embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

Therefore, the embodiments of the present disclosure are provided to explain the spirit and scope of the present disclosure, but not to limit them. The spirit and scope of the present disclosure is not limited by the described embodiments. The scope of the present disclosure should be construed on the basis of the accompanying claims, and all the technical ideas within the scope equivalent to the claims should be included in the scope of the present disclosure.

Embodiments of the present disclosure may obtain and share information related to an accident through at least some vehicles related to the accident by using V2X.

Moreover, embodiments of the present disclosure may provide an environment for exchanging or sharing accident-related information.

Furthermore, embodiments of the present disclosure may accurately analyze accurately analyzes an accident by collecting various pieces of information related to the accident.

Moreover, a variety of effects directly or indirectly understood through the present disclosure may be provided.

Hereinabove, although the present disclosure was described with reference to certain embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

What is claimed is:

1. A vehicle control apparatus comprising:
at least one sensor configured to identify an accident occurring in a vehicle; and
a processor configured to transmit an accident signal, indicating occurrence of the accident, to an external electronic device based on identifying the occurrence of the accident in the vehicle by using the at least one sensor.

2. The vehicle control apparatus of claim 1, wherein the processor is further configured to transmit information related to the accident to the external electronic device.

3. The vehicle control apparatus of claim 2, wherein the information related to the accident includes at least one of a location at which the accident occurs, image information of specified duration including a time point at which the accident occurs, traffic situation information within a specified radius from the location after the accident occurs, vehicle information of the vehicle, a number of passengers in the vehicle, age information of one or more passengers in the vehicle, gender information of one or more passengers in the vehicle, a target to which the information related to the accident is to be transmitted, a rescue signal for the accident, or any combination thereof.

4. The vehicle control apparatus of claim 1, wherein:
the processor is configured to transmit at least one of i) the accident signal or ii) information related to the accident to one or more external vehicles identified within a specified distance from the vehicle, based on identifying the occurrence of the accident; and
the one or more external vehicles allow, in advance, reception of at least one of the accident signal or the information related to the accident.

5. The vehicle control apparatus of claim 4, wherein the processor is further configured to cause the information related to the accident to be displayed through one or more displays included in the one or more external vehicles.

6. The vehicle control apparatus of claim 1, wherein the processor is further configured to:
transmit location information, indicating a location at which the accident occurs, to the external electronic device; and
transmit a rescue signal for causing at least one of an ambulance, a fire truck, a police car, or any combination thereof to be dispatched to the location specified by the location information.

7. The vehicle control apparatus of claim 1, wherein the processor is configured to transmit the accident signal to at least one of the external electronic device, an external vehicle, or any combination thereof, identified within a specified radius from the vehicle.

8. The vehicle control apparatus of claim 3, wherein the processor is configured to:
identify at least one external vehicle identifying the accident by using the image information; and
cause the external electronic device to transmit a request signal requesting information related to the accident to the at least one external vehicle.

9. A vehicle control apparatus comprising:
at least one sensor configured to identify an accident occurring in an external vehicle; and
a processor configured to transmit an accident signal, indicating occurrence of the accident in the external vehicle, to an external electronic device based on identifying the occurrence of the accident in the external vehicle by using the at least one sensor.

10. The vehicle control apparatus of claim 9, wherein the processor is further configured to transmit information related to the accident to the external electronic device.

11. The vehicle control apparatus of claim 10, wherein the information related to the accident includes at least one of a location at which the accident occurs, image information of specified duration including a time point at which the accident occurs, traffic situation information within a specified radius from the location after the accident occurs, vehicle information of the external vehicle, a number of passengers in the external vehicle, age information of one or more passengers in the external vehicle, gender information of one or more passengers in the external vehicle, a target to which the information related to the accident is to be transmitted, a rescue signal for the accident, or any combination thereof.

12. The vehicle control apparatus of claim 9, wherein the processor is configured to transmit, to the external electronic device, image information of specified duration including a time point at which the accident occurs.

13. The vehicle control apparatus of claim 9, wherein the processor is configured to provide the external electronic device with information related to the accident based on receiving, from the external electronic device, a request signal requesting the information related to the accident.

14. The vehicle control apparatus of claim 10, wherein the information related to the accident is stored in at least one of the external electronic device, a communication relay station different from the external electronic device, a server storage associated with the external vehicle or a vehicle equipped with the vehicle control apparatus, an electronic device including a terminal owned by a pedestrian, or any combination thereof, when the information related to the accident is transmitted to the external electronic device.

15. A communication method, the method comprising:
transmitting, by at least one of a first vehicle in which an accident occurs, a second vehicle that identifies occurrence of the accident by using a sensor, or any combination thereof, an accident signal indicating the occurrence of the accident occurs, through a communication circuit;
receiving a request signal requesting information related to the accident from a communication center responding to the accident signal; and
transmitting, by at least some vehicles responding to the request signal, the information related to the accident to the communication center,
wherein vehicles, among the at least some vehicles, agree to transmission of the information related to the accident to the communication center.

16. The method of claim 15, wherein the information related to the accident includes at least one of a location at which the accident occurs, image information of specified duration including a time point at which the accident occurs, traffic situation information within a specified radius from the location after the accident occurs, vehicle information of the first vehicle, a number of passengers in the first vehicle, age information of one or more passengers in the first vehicle, gender information of one or more passengers in the first vehicle, a target to which the information related to the accident is to be transmitted, a rescue signal for the accident, or any combination thereof.

17. The method of claim 15, further comprising transmitting the request signal requesting the information related to the accident to vehicles identified in image information based on receiving, from the first vehicle, the image information within specified duration from a time point at which the accident occurs.

18. The method of claim 15, further comprising:
identifying at least one of a location of the first vehicle, a location where the accident occurs, or any combination thereof, based on map information; and
transmitting a request signal requesting the information related to the accident to at least one of i) one or more vehicles located within a specified radius from a location of the first vehicle or a location at which the accident occurs, ii) one or more vehicles passing the specified radius for a specified duration, or any combination thereof.

19. The method of claim 15, further comprising:
requesting vehicle information related to the accident from the first vehicle; and
providing an environment in which one or more vehicles other than the first vehicle and the first vehicle share the information related to the accident with each other,
wherein the vehicle information includes at least one of an identifier of the first vehicle, a location at which the accident occurs, a number of passengers in the first vehicle, age information of one or more passengers in the first vehicle, gender information of one or more passengers in the first vehicle, a target to which the information related to the accident is to be transmitted, a rescue signal for the accident, or any combination thereof, and
wherein the information related to the accident includes at least one of image information of specified duration including a time point at which the accident occurs, traffic situation information within a specified radius from the location after the accident occurs, a location where the accident occurs, information related to an accident victim by the accident, or any combination thereof.

20. The method of 41 claim 15, further comprising link establishing a communication through the communication circuit from the first vehicle and the second vehicle before the accident occurs.
